(19) United States
(12) Patent Application Publication
(10) Pub. No.: US 2024/0293207 A1
(43) Pub. Date: Sep. 5, 2024

(54) Flossing Device and Methodology

(71) Applicant: Bennington Oral Health, Newton, MA (US)

(72) Inventors: Van Orenstein, Newton, MA (US); Aaron Double, Newton, MA (US)

(21) Appl. No.: 18/178,315

(22) Filed: Mar. 3, 2023

(51) Int. Cl. A61C 15/04

(52) U.S. Cl. CPC A61C 15/046

(57) ABSTRACT

A device and methodology for flossing teeth. The device includes a body having a first arm and a second arm. The first and second arms connect at a vertex. The first and second arms extend distally from the vertex and cross over each other at a crossing over region, so that transverse movement of the first arm relative to the second arm between the vertex and the crossing over region causes an opposite transverse movement at distal ends of the first arm and the second arm. A length of dental floss is coupled between the distal ends of the first arm and the second arm at first and second attachment positions. When in a neutral position with no forces applied to the first arm and the second arm, the distance between the first and second attachment positions is smaller, and the dental floss looser, relative to when the first and second arms are squeezed together between the vertex and crossing over region such that distance between the first and second attachment positions is larger, and the dental floss tauter.

### TECHNICAL FIELD

The present invention relates to a flossing device and methodology, and more particularly to a flossing device and methodology for flossing that utilizes reverse action mechanism suitable for C-shaped flossing.

### BACKGROUND ART

Dental decay commonly occurs in two distinct areas of the mouth and teeth. The first area is the chewing surface (i.e., the occlusal surface) of the molars. This area is easily cleaned with a toothbrush. The second area is the interproximal area that is the area in between the teeth. Since there is typically contact between teeth in this area, a toothbrush cannot easily penetrate through the contact and thus cannot effectively clean it. The teeth that most commonly have interproximal decay are the molars due to their larger, broader, flatter contacts. This is a much larger area that cannot be accessed by a toothbrush. As there are two teeth for every interproximal contact, flossing is recommended so as to clean the side of one tooth and then clean the side of the other tooth, removing any plaque or food stuck in between the teeth.

The periodontium is the specialized tissue that surrounds and supports the teeth in the mouth. Parts of the periodontium include the gums, ligaments, and bone. Keeping these areas healthy are crucial for overall health. Periodontal disease is caused by pathology with these anatomical structures. Chronic periodontal disease is commonly associated with gum and bone loss, called recession. Periodontal diseases can predispose individuals to several systemic diseases such as cardiovascular disease, oral and colorectal cancer, gastrointestinal diseases, respiratory tract infection and pneumonia, adverse pregnancy outcomes, diabetes and insulin resistance, and Alzheimer's disease. The most common reason for periodontal disease is inflammation of the periodontium caused by improper cleansing of the area. Again, dental floss, used properly, is the most effective and widely accepted tool to prevent periodontal disease.

Flossing often requires holding a length of floss taut and inserting it between the teeth. Because the contact between teeth is often tight, some people have challenges in getting string floss through the contact. The string floss needs to have a lot of tension to pass through the contact. Furthermore, many people dislike string floss because, for example, they do not like wrapping it around their fingers, they can't figure out how to make it tense enough, it hurts to push down so hard and/or they have fine motor issues with the flossing motion.

Instead of simply moving the floss, tightly held in a straight line, in an up down motion between the teeth, C-shaped flossing is recommended by the American Dental Association (ADA) to properly clean the area between the teeth. FIG. 1 shows a tooth being cleaned using string C-shaped flossing. C-shaped flossing typically includes dispensing a length of floss, and under tension, sliding a section of the floss between your teeth. When the floss reaches the gumline, the floss is curved into a C-shape against one tooth and gently slid into the space between the gum and the tooth. Holding the floss tightly against the tooth, the side of the tooth is gently rubbed, moving the floss away from the gum with up and down motions. By pulling it in a curve around the side of a tooth, plaque clinging to the sides of your teeth, which a rigid floss pick would miss, is advantageously eliminated.

People who have issues with traditional string floss may elect to use stick flossers/devices. However, flossing with stick flossers is not as effective. Flossers will make it through the contact of the teeth, but due to their rigid nature will not clean down the side of one tooth and down the side of the other tooth in the interproximal region. A flosser with a fixed taut floss length simply does not have enough slack in the floss loop to form the required “C” shape around the base of the tooth. Furthermore, they often hurt when you push them down and they may get stuck because they're not adjustable. The current flossing devices are not adjustable and cannot accommodate for different sized mouths and teeth, making proper flossing difficult to impossible for many. Because of their tautness, typical stick flossers cannot adapt to the tooth, much less perform C-shaped flossing. Instead, they haphazardly push into the gum tissue without direction, intent, or caution, and may damage the papillary interproximal gingiva. This is why dental hygienists often recommend that their patients use regular string floss with a C-shaped technique. Conventional flossing devices are simply too taut, require too many parts/are complex or allow for minimal adjustments in floss tautness that are unsatisfactory for C-shaped flossing.

### SUMMARY OF THE EMBODIMENTS

In accordance with one embodiment of the invention, a device for flossing teeth is provided. The device includes a body having a first arm and a second arm. The first and second arms connect at a vertex. The first and second arms extend distally from the vertex and cross over each other at a crossing over region, so that transverse movement of the first arm relative to the second arm between the vertex and the crossing over region causes an opposite transverse movement at distal ends of the first arm and the second arm. A length of dental floss is coupled between the distal ends of the first arm and the second arm at first and second attachment positions. When in a neutral position with no forces applied to the first arm and the second arm, the distance between the first and second attachment positions is smaller, and the dental floss looser, relative to when the first and second arms are squeezed together between the vertex and crossing over region such that distance between the first and second attachment positions is larger, and the dental floss tauter.

In accordance with related embodiments of the invention, when the first and second arms are squeezed together between the vertex and the crossing over region, the distance between the first and second attachment positions is substantially 17.5 mm, and when the first and second arms are in the neutral position, the distance between the first and second coupling positions is substantially 14.8 mm.

In accordance with related embodiments of the invention, the difference in distance between the first and second attachment positions when in the neutral position compared to when the first and second arms are squeezed together between the vertex and the crossing over region may be greater than or equal to 2.0 mm.

In accordance with related embodiments of the invention, the first arm and the second arm are resilient. The body may be a single, integral piece of the same material. The body may be injection molded. The body may be made of ABS (Acrylonitrile Butadiene Styrene). The dental floss may extend into the distal ends of the first arm and the second arm, so as to secure the length of dental floss to the body.

In accordance with further related embodiments of the invention, a method of using the above-described device includes squeezing the first and second arms together between the vertex and the crossing over region, such that dental floss coupled between the first and second attachment positions becomes taut. The dental floss device is inserted between two teeth. The method may further include holding the first and second arms in the neutral position, such that the dental floss coupled between the first and second attachment positions becomes slack. C-shaped flossing may then be performed against at least one of the two teeth.

### BRIEF DESCRIPTION OF THE DRAWINGS

The foregoing features of embodiments will be more readily understood by reference to the following detailed description, taken with reference to the accompanying drawings, in which:

FIG. 1 (prior art) shows a tooth being cleaned using string C-shaped flossing;

FIGS. 2A-B shows a dental floss device, in accordance with an embodiment of the invention. More particularly, FIG. 2A shows the dental floss device when the floss is taut, and FIG. 2B shows the dental floss device when the floss is slack;

FIGS. 3A-3I show various isometric views of the dental floss device (without the floss), in accordance with an embodiment of the invention. More particularly, FIG. 3A shows a top view of the dental floss device; FIGS. 3B and 3C show front and back views of the dental floss device; FIGS. 3D and 3E show upward angled views of the dental floss device; FIGS. 3F and 3G show left and right side views of the dental floss device; and FIGS. 3H and 3I show downward angled views of the dental floss device; and

FIG. 4 shows a flowchart depicting steps when using the dental floss device of FIG. 2 to perform C-shaped flossing, in accordance with an embodiment of the invention.

### DETAILED DESCRIPTION OF SPECIFIC EMBODIMENTS

As used herein, the term “reverse action” refer to devices that include a mechanism that causes separate tips at one end of the apparatus to move away from one another as corresponding arm portions at an opposite end of the device are pushed transversely towards each other. Conversely, the release of the transverse force that was pushing adjacent arm portions of the device together results in causing movement of the tips of the device towards each other.

In illustrative embodiments of the invention, a dental floss device and methodology is provided that slackens the floss to allow for C-flossing when the device is in a neutral position, and draws the floss taut when the device is squeezed so the floss can be slid between teeth. The body of the device may advantageously be made of a single, integral piece of the same material, reducing cost and manufacturing complexity. Details are described below.

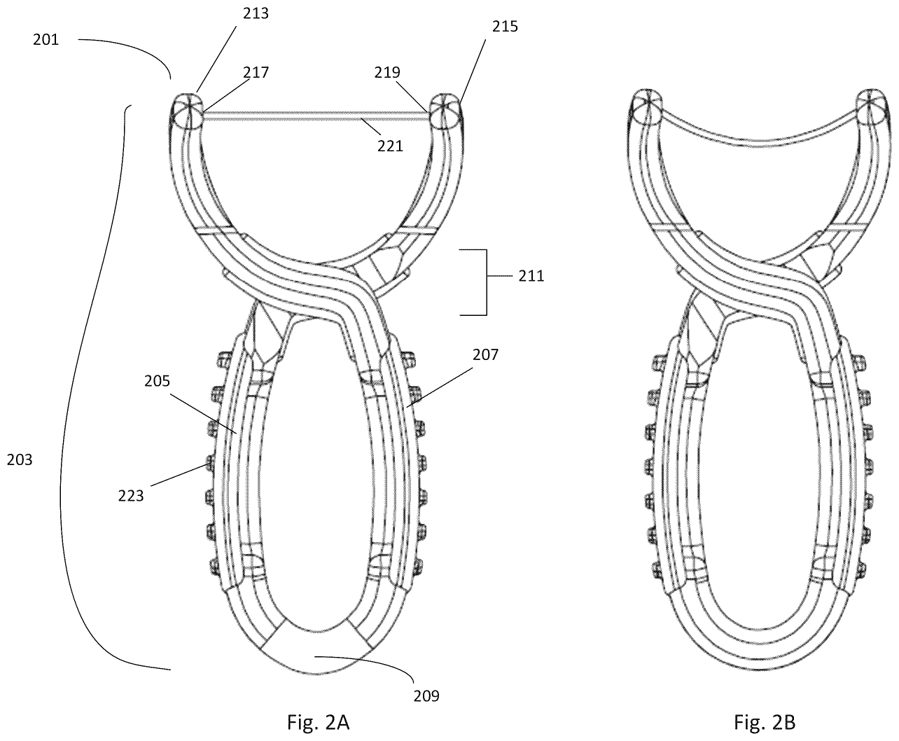

FIGS. 2A-B shows a dental floss device 201, in accordance with an embodiment of the invention. More particularly, FIG. 2A shows the dental floss device 201 when the floss 221 is taut (e.g., for when sliding the floss between the teeth), and FIG. 2B shows the dental floss device 201 when the floss 221 is slack (i.e., in the neutral position) to allow for C-flossing.

The dental floss device 201 includes a body 203 having a first arm 205 and a second arm 207. The first and second arms 205 and 207 are connected at a vertex 209. Vertex 209 may act, for example, as a living hinge that integrally connects first and second arms 205 and 207 together. The first and second arms 205 and 207 extend distally from the vertex 209 and cross over each other at a crossing over region 211. Transverse movement of the first arm 205 relative to the second arm 207 between the vertex 209 and the crossing over region 211 causes an opposite transverse movement at distal ends 213 and 215 of the first arm 205 and the second arm 207 (i.e., a “reverse action”).

The body 203 of the dental floss device 201 may be flexible and/or resilient. The body 203 may be made of a single, integral piece of the same material, reducing cost and complexity. In various embodiments, the body may be made of Acrylonitrile Butadiene Styrene (ABS). Alternatively, the dental floss device 201 may be made of multiple parts. For example, the arms may be separate parts that are mechanically coupled at the vertex.

The body 203 may be, for example, injection molded. Illustratively, the floss 221 may be positioned in the injection mold such that it is held in place while the plastic (or other material used for the body 203) is being injected. Within the top of the arms 205 and 207, plastic flows around the floss, locking it in the proper place. The tension on the floss 221 may be defined by a ramped indent positioned outside the mold that the floss 221 must traverse, allowing for an appropriate amount of slack to set the tension on the floss. Once the plastic is set, one side of the mold can be opened and a cutter may cut the floss between the dental floss devices 201. Once cut, the dental floss devices 201 can be ejected from the mold. The cross over region 211 of the dental floss device 201 may be made by using an insert in the mold, allowing the plastic material to cross over itself without touching, allowing for free movement between the two arms 205 and 207.

The length of dental floss 221 is coupled between the distal ends 213 and 215 of the first arm 205 and the second arm 207 at first and second attachment positions 217 and 219. The floss 221 may be, for example, a continuous strand of multifilamented ultra high molecular weight polyolefin, nylon or Teflon/PTFE. To secure the length of dental floss 221 to the device 201, end portions of the dental floss 221 may be, without limitation, embedded into first and second arms 205 and 207 during an injection molding process, as described above, with or without the use of, for example, eyelets at the first and second attachment positions 217 and 219. In various embodiments, alone or in combination with injection molding, fixed anchors may be positioned at first and second attachment positions 217 and 219, to secure the length of dental floss 221 to the body 203. The floss may also be adhesively attached to the arms 205 and 207.

In various embodiments of the invention, the dental floss device 201 may allow for the replacement of the dental floss 221, or an adjustment in the length of the dental floss 221. Illustratively, anchors at the first and second attachment positions 217 and 219 may be removably attached to the dental floss device 201 such that when desired, they can be replaced with new anchors and associated dental floss, or simply threaded with new dental floss (e.g., the anchors may include mechanical mechanisms for locking/unlocking the floss in place, as known in the art).

Due to the reverse action of the dental floss device 201, when in a neutral position with no forces applied to either the first arm 205 and the second arm 207, the distance between the first and second attachment positions 217 and 219 is smaller, and thus the length of dental floss 221 is looser, relative to when the first and second arms 205 and 207 are squeezed together between the vertex 209 and crossing over region 211. When squeezed, the distance between the first and second attachment positions 217 and 219 becomes larger and consequently, the length of dental floss 221 taut. Since the arms 205 and 207 cross over each other at crossing over region 211, the action of the arms prior to the crossing over region 211 has an opposite effect on the first and second attachment positions 217 and 219, causing them to move away from each other, making the dental floss 221 taut. Conversely, as shown in FIG. 2B, when the transverse or squeezing pressure is released distal ends of arms 205 and 207 move back to their neutral position, causing the floss to slacken.

To provide more comfort, better control and or prevent slipping, gripping elements 223 may be positioned between the vertex 209 and crossing over region 211 on each or one of the arms 205 and 207. The gripping elements 223 may include a pad and/or extra material having various uneven surfaces and/or grooves, and/or cushioning materials. Gripping elements 223 make the dental floss device 201 easy to hold and control. The ability to easily enhance or slacken tension by easily applying force on arms 205 and 207 promotes the use of C-flossing to prevent tooth decay, regardless of one's age or ability, including the elderly or the very young who may lack coordination.

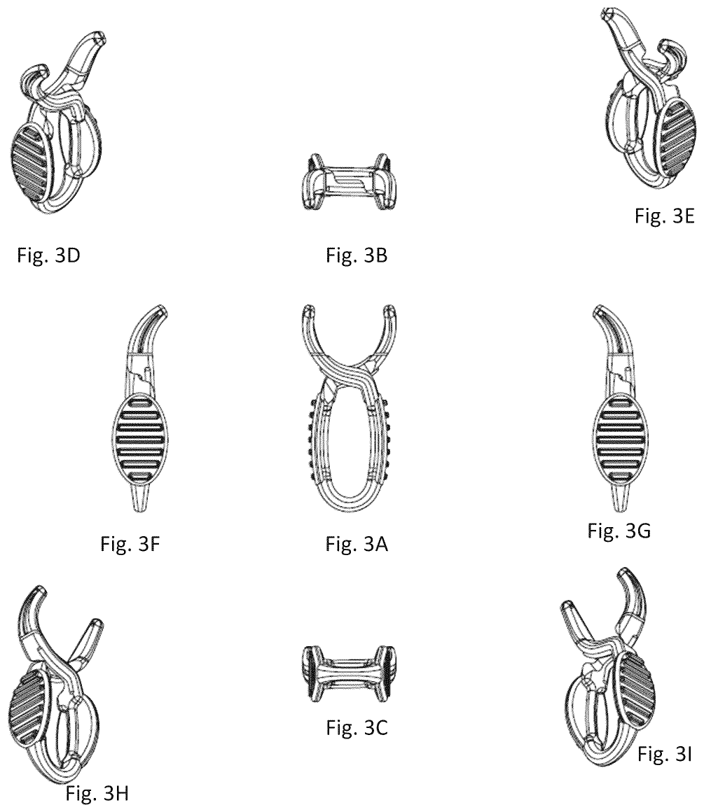

FIGS. 3A-3I show various isometric views of the dental floss device (without the floss), in accordance with an embodiment of the invention. More particularly, FIG. 3A shows a top view of the dental floss device; FIGS. 3B and 3C show front and back views of the dental floss device; FIGS. 3D and 3E show upward angled views of the dental floss device; FIGS. 3F and 3G show left and right side views of the dental floss device; and FIGS. 3H and 3I show downward angled views of the dental floss device.

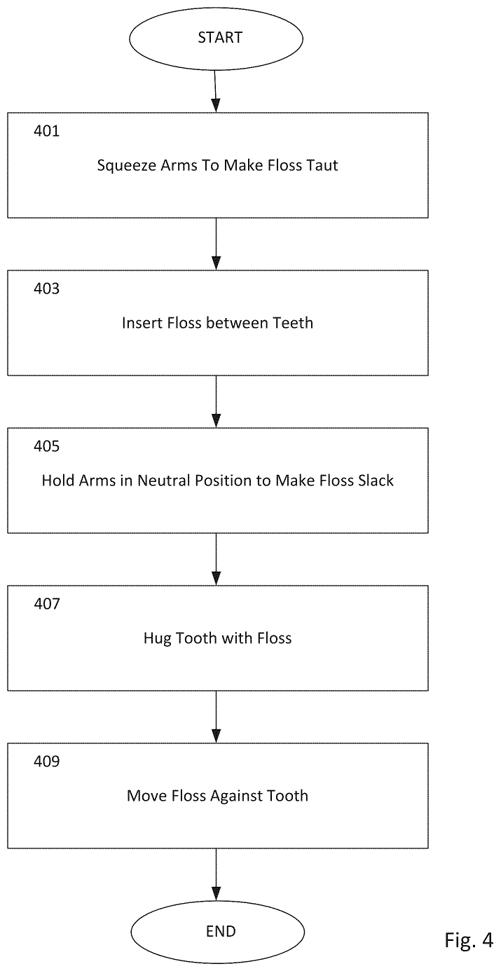

FIG. 4 shows a flowchart depicting steps when using the dental floss device of FIG. 2 to perform C-shaped flossing, in accordance with an embodiment of the invention. The user grips the device 201 and squeezes arms 205 and 207 between the vertex 209 and the crossing over region 211, step 401. As described above, this causes the length of dental floss 221 to become taut. The user then slides the floss 221 between two teeth, step 403. At step 405, the user releases the pressure on arms 205 and 207 and holds the dental floss device 201 in the neutral position, such that the dental floss 221 becomes slack. The user then hugs the front or back tooth with the dental floss 221, while gently sliding the floss 221 into the space between the gum and the tooth, step 407. The floss is then moved away from the gum with up and down motions, step 409. The user may then repeat steps 407 and 409 for the other of the front or back tooth.

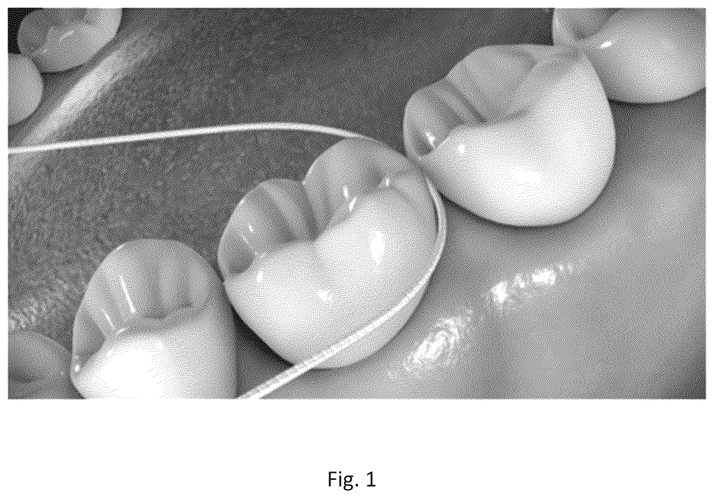

Referring back to FIG. 1, proper C-flossing technique requires enough slack in the dental floss 221 to hug the tooth. This amount of slack cannot be achieved with conventional flossers. And while certain flossing devices allow for such slack, they are complex and require multiple parts. In an exemplary embodiment, when the first and second arms are squeezed together between the vertex and the crossing over region, the distance between the first and second attachments positions is 17.5 mm, and when the first and second arms are in the neutral position, the distance between the first and second attachment positions is 14.8 mm. The difference in distance between the first and second attachment positions when in the neutral position compared to when the first and second arms are squeezed together between the vertex and the crossing over region is thus 2.7 mm. However, this is not limiting, and in various embodiments of the invention, the difference in distance between the first and second attachment positions when in the neutral position compared to when the first and second arms are squeezed together between the vertex and the crossing over region is a design choice, and may be, without limitation, greater than or equal to 2.0 mm (eg., 2.0 mm, 2.5 mm or 3.0 mm).

The embodiments of the invention described above are intended to be merely exemplary; numerous variations and modifications will be apparent to those skilled in the art. All such variations and modifications are intended to be within the scope of the present invention.

What is claimed is:

1. A device for flossing teeth, the device comprising:
a body having a first arm and a second arm, the first and second arms connected at a vertex, the first and second arms extending distally from the vertex and crossing over each other at a crossing over region, so that transverse movement of the first arm relative to the second arm between the vertex and the crossing over region causes an opposite transverse movement at distal ends of the first arm and the second arm;
a length of dental floss coupled between the distal ends of the first arm and the second arm at first and second attachment positions;
wherein when in a neutral position with no forces applied to the first arm and the second arm, the distance between the first and second attachment positions is smaller, and thus the length of dental floss looser, relative to when the first and second arms are squeezed together between the vertex and crossing over region such that distance between the first and second attachment positions is larger and the length of dental floss tauter.

2. The device according to claim 1, wherein when the first and second arms are squeezed together between the vertex and the crossing over region, the distance between the first and second attachments positions is substantially 17.5 mm, and when the first and second arms are in the neutral position, the distance between the first and second attachment positions is substantially 14.8 mm.

3. The device according to claim 1, wherein the difference in distance between the first and second attachment positions when in the neutral position compared to when the first and second arms are squeezed together between the vertex and the crossing over region is greater than or equal to 2.0 mm.

4. The device according to claim 1, wherein the first arm and the second arm are resilient.

5. The device according to claim 1, wherein the body is a single, integral piece of the same material.

6. The device according to claim 1, wherein the body is injection molded.

7. The device according to claim 1, wherein the body is made of ABS (Acrylonitrile Butadiene Styrene).

8. The device according to claim 1, wherein the dental floss extends into the distal ends of the first arm and the second arm, so as to secure the dental floss to the body.

9. A method of using the device of claim 1, the method comprising:
squeezing the first and second arms together between the vertex and the crossing over region, such that dental floss coupled between the first and second attachment positions becomes taut;
inserting the dental floss between two teeth.

10. The method according to claim 9, further comprising:
holding the first and second arms in the neutral position, such that the dental floss coupled between the first and second attachment positions becomes slack.

11. The method according to claim 10, further comprising performing C-shaped flossing against at least one of the two teeth.
